(19) United States
(12) Patent Application Publication
(10) Pub. No.: US 2018/0275062 A1
(43) Pub. Date: Sep. 27, 2018

(54) Optical Method of Detecting Bacteria

(71) Applicant: Pamela A. Boss, San Diego, CA (US)

(72) Inventor: Pamela A. Boss, San Diego, CA (US)

(73) Assignee: United States of America, as Represented by the Secretary on the Navy, Arlington, VA (US)

(21) Appl. No.: 13/775,974

(22) Filed: Feb. 25, 2013

(51) Int. Cl. G01N 21/64

(52) U.S. Cl. CPC G01N 21/6486

(57) ABSTRACT

A device and method for determining total bacteria count in a sample can include the step of removing the eukaryotes from the sample by filtering the sample through a 0.45 μm pore size syringe filter made of a low protein binding material. Next, the sample can be tagged with a fluorescent tag and illuminated with a light source at an excitation wavelength for the fluorescent tag. The resulting fluorescent intensity can be compared to a calibration curve to determine the total bacteria count. In cases where a total bacteria count of a specific bacteria is desired, a phage that is known to react with the bacteria of interest can fluorescently tagged and then mixed into the sample, and the combination can be illuminated to establish a test intensity for said sample, which can be used to obtain a total bacteria count for the bacteria species of interest.

### FEDERALLY-SPONSORED RESEARCH AND DEVELOPMENT

This invention (Navy Case No. 101322) is assigned to the United States Government and is available for licensing for commercial purposes. Licensing and technical inquires may be directed to the Office of Research and Technical Applications, Space and Naval Warfare Systems Center, Pacific, Code 72120, San Diego, Calif. 92152; voice (619) 553-5118; email ssc pac T2®navy.mil.

### FIELD OF THE INVENTION

The present invention pertains generally to detection of bacteria. More specifically, the present invention pertains to the optical detection of bacteria using fluorescent tags. The invention is particularly, but not exclusively, useful for obtaining total bacteria counts, or total counts of a specific bacteria of interest, in a sample.

### BACKGROUND OF THE INVENTION

Total bacterial counts are often used to assess water quality for both recreation and drinking purposes (in water), as well to test for raw milk quality (for milk), aquaculture, etc. Currently, total bacterial counts are done using methods that incorporate standard plate count (SPC), which can take up to 48 hours. Alternatively, flow cytometers can be used to determine a total bacteria count, but flow cytometers are expensive and sophisticated devices.

In some instances, phages can be used to obtain total bacteria counts for a specific bacteria-of-interest. Phages are viruses whose hosts are bacterial cells. The phages identify their hosts through host cell-specific receptor molecules, which are located on the outside of the host cell. Once the phages find their specific receptors, they bind to the bacterial cell and inject their nucleic acid into the cell. The phage nucleic acid then takes over the host cell's machinery to make large amounts of phage components. The phage components are then assembled into new phages. The phages then direct production of an enzyme that breaks down the bacteria cell wall, which causes the bacteria to lyse, which further frees new phages. Phage lysis assays are known in the prior art for the detection and identification of various bacterial pathogens.

Antibodies have also been used to discriminate bacterial species. However there are a number of advantages to using phage-based detection schemes, as opposed to using antibody-based schemes. More specifically, antibodies are bare protein molecules. As such, they are potential food sources for bacteria. Bacterial “grazing’ of antibody-coated magnetic microparticles has been observed. Such grazing can result in false positives, when compared to a phage-based scheme. Other limitations of antibody-based immunoassays include antibody manufacturability and instability. To overcome these disadvantages, phages can be use in lieu of antibodies for the detection of bacteria.

As mentioned above, phages can also be used to detect and identify specific bacteria. This is because each bacterial species has at least one phage that will prey upon it. Phages can be readily obtained from phage libraries. One such library is the Felix D'Herelle Reference Center for Bacterial Viruses at Laval University in Quebec, Canada. This library has a collection of approximately 500 different species of phage. Phages are very robust and are not as sensitive to environmental conditions (pH, temperature, salinity, etc.) as antibodies are. Large quantities of phages can be easily cultured and purified. Additionally, the purified phage exhibits a long shelf life relative to antibodies.

In view of the above, it is an object of the present invention to provide a device and method for detecting total bacteria counts in a sample that minimizes false positives. Another object of the present invention is to provide a device and method for detecting total bacteria counts in a sample that is stable and that can easily be stored for extended periods of time prior to use. Still another object of the present invention is to provide an optical device and method for detecting bacteria that can use phages to determine a total count of a bacteria of interest that is known to react with the phage being used. Yet another object of the present invention to provide a device and method for detecting total bacteria count using fluorescent tags that is easy to manufacture, that is inexpensive, and that is easy to use by remote operators in the field.

### SUMMARY OF THE INVENTION

A device and method for determining total bacteria count in a sample, with the sample containing eukaryotes and prokaryotes, can include the initial step of removing the larger eukaryotes from the sample. One way to remove the eukaryotes is by filtering the sample through a 0.45 μm pore size syringe filter. The syringe filter can be made of a low protein binding material, such as a polycarbonate (PC) or polyvinylidene (PVDF) material. Next, the sample can be tagged with a fluorescent tag and then filtered on an optical substrate for detection. The substrate is illuminated with a light source at a wavelength corresponding to an excitation wavelength for said fluorescent tag, to establish a test intensity for said sample. The test intensity can be compared to reference intensities, such as those embodied in calibration curves for example, to determine said total bacteria count.

In cases where a total bacteria count of a specific bacteria is desired, a phage that is known to react with the bacteria of interest can be selected. The phage can be fluorescently tagged and then mixed into the sample, and the resulting mixture is filtered on an optical substarte the can be illuminated with a light source at a wavelength corresponding to an excitation wavelength for the fluorescent tag, to establish a test intensity for the sample. The test intensity can be compared to reference intensities corresponding to determine said total bacteria count for that bacteria of interest. In several embodiments, the fluorescent tag can be SBYR® Gold cyanine dye. The bacteria count in the sample can also be optionally fixed by using a solution of 4% paraformaldehyde in phosphate buffer solution (PBS). The fixing allows for verification of the total bacteria count using alternative methods, such as optical microscopy, for example.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The novel features of the present invention will be best understood from the accompanying drawings, taken in conjunction with the accompanying description, in which similarly-referenced characters refer to similarly-referenced parts, and in which:

FIG. 1 is a block diagram which can be used to describe the methods of the present invention according to several embodiments;

FIG. 2a is top plan view of the device of the present invention, according to several embodiments;

FIG. 2b is a side-elevational view of the Anodisc membrane filter portion (optical substrate) of the device of FIG. 2a;

FIGS. 3A-3B are color photographs of bacteria and phages that have been tagged with DAPI fluorescent tag and SYBR® gold fluorescently labeled phage DNA and magnified 1000×;

FIG. 4 is a block diagram which can be used to describe the methods of the present invention according to several alternative embodiments; and,

FIG. 5 is an illustration of an intensity calibrations curve for the device and methods according to several embodiments.

### DETAILED DESCRIPTION OF THE EMBODIMENTS

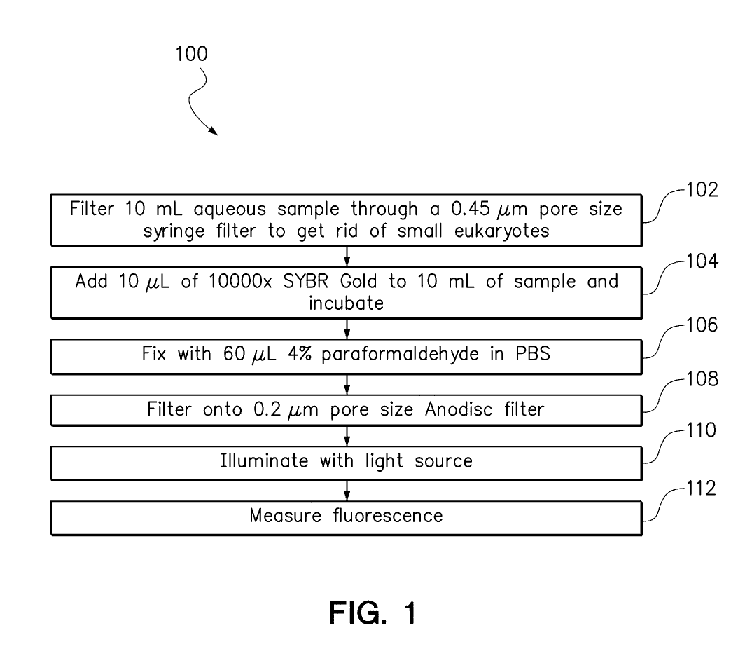

Referring initially to FIG. 1, a block diagram can be used to describe the methods 100 of the present invention for obtaining a total bacteria count for a sample, according to several embodiments. An aqueous sample can contain multiple species of eukaryotes and prokaryotes. Eukaryotes are organisms that have a cell nucleus. Single celled eukaryotes include amoeba, algae, and other protozoans. Prokaryotes are organisms that lack a cell nucleus. Bacteria are examples of prokaryotes. Eukaryotes tend to be larger in size than prokaryotes. Thus, to remove the eukaryotes from the sample, and as indicated by step 102, a representative 10 mL volume (the actual volume used is not critical, provided the volume of sample that is used is known and accounted for when using calibration curves as described below) of sample can be filtered to remove the eukaryotes. One way to accomplish step 102 is through a 0.45 μm pore size syringe filter. Either polycarbonate (PC) or polyvinylidene (PVDF) filters can be used as they exhibit low protein binding. Other types of filters could be used, provided the filter is sized so that eukaryotes are filtered out, but prokaryotes pass through the filter as the sample is filtered.

Once the sample has been filtered to substantially remove the eukaryotes, the resulting sample can be fluorescently tagged. As indicated by step 104 in FIG. 1, one way to do this is by adding 10 μL of 10000× SYBR® gold to the sample. The SYBR® gold will permeate through the cell wall of the bacteria (if any) in the sample and bind to the bacteria DNA. In some embodiments the method 100 can add the optional step 106 of fixing the bacteria count in the sample, by preserving the bacteria. To do this, 60 μL of 4% paraformaldehyde in phosphate buffer solution (PBS) can be added to the sample. Step 106 preserves the sample for additional analysis (verification of bacteria count) by an alternative method, such as epifluorescent microscopy.

Referring again to FIG. 1, once the sample is fluorescently tagged (step 104), the sample can be filtered onto an optical substrate such as a 0.2 μm pore size Anodisc membrane filter, as shown by step 108. The Anodisc membrane filter can be illuminated with a light source, as shown by step 110, and the resulting fluorescence can be measured, as shown in step 112.

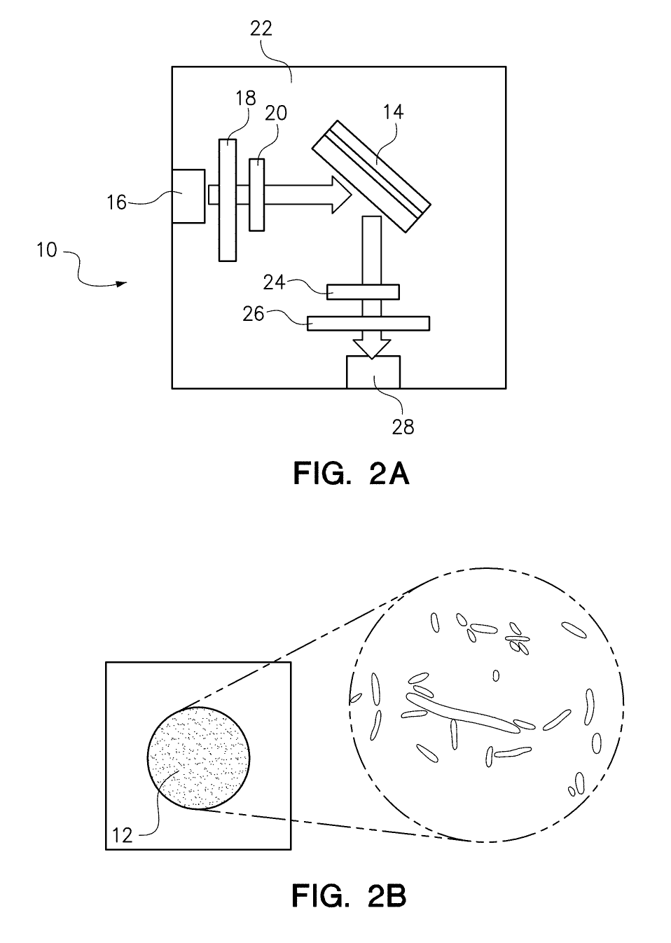

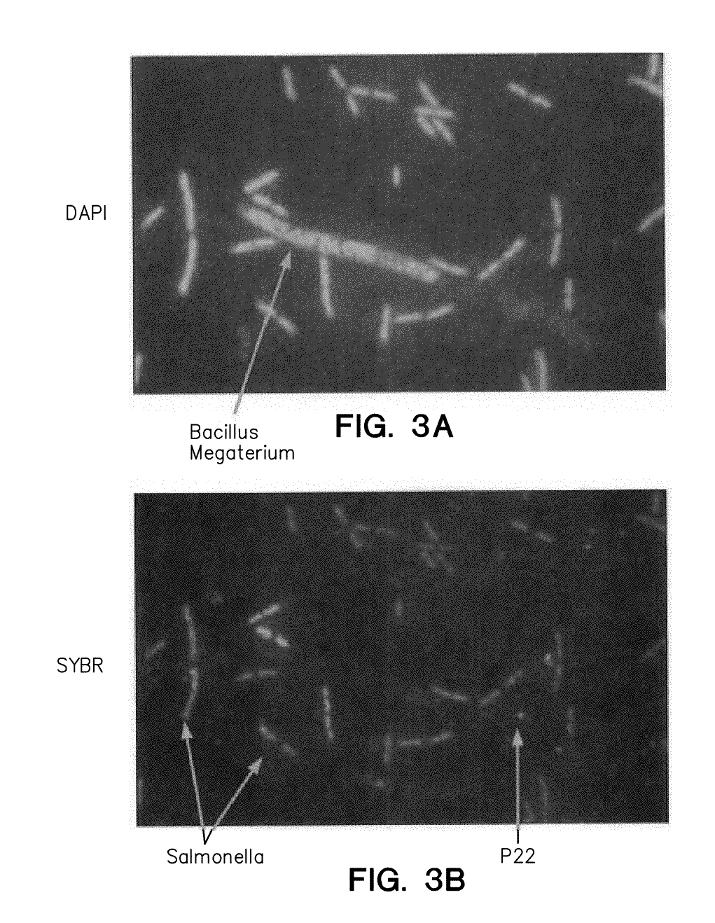

Referring now to FIG. 2, the device for optical detection of bacteria is shown and is generally designated by reference character 10. Shown, device 10 can include the aforementioned optical substrate, Anodisc membrane filter 12. The filter 12 can be placed in a sample holder 14, as shown in FIG. 3. A light source 16 can be used to illuminate the sample holder and excite the fluorescence of the SYBR® gold. To do this, the light source 16 can be a LED that emits at the excitation wavelength for SYBR® gold or a xenon arc lamp. A lens 18 can collimate the light from light source 16. An excitation filter 20 (which can be needed in cases where a xenon arc lamp is used as light source 16) can allow light of the appropriate wavelength to excite SYBR® gold, into the sample chamber 22. In the embodiments where SYBR® gold is used as a fluorescent tag, the light source can illuminate at a wavelength between 450 and 550 nanometers (450 nm<λ<550 nm). The light can enter the sample chamber 22 and impinge on Anodisc membrane filter 12, which can cause the SYBR® gold bound on the bacterial DNA to fluoresce.

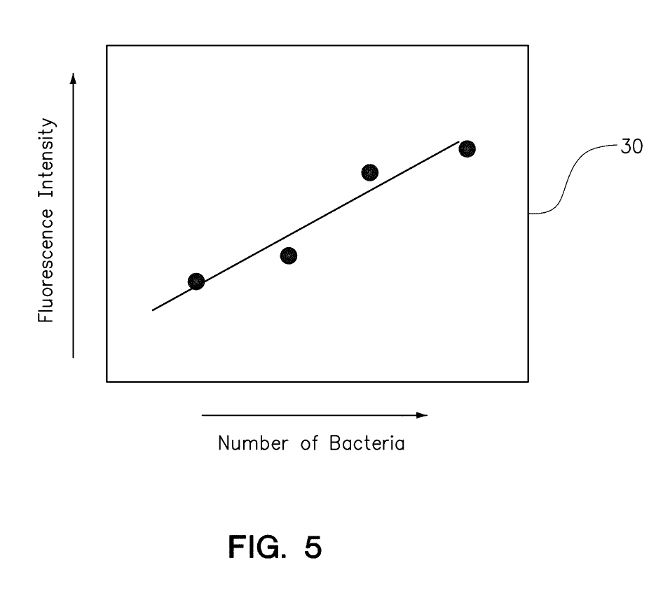

A collecting lens 24, which can be oriented 90° from the excitation light, can collect the fluorescence emitted by the SYBR® gold stained bacterial cells. Collecting lens 24 can include an emission filter 26 that blocks the excitation light and only lets the light due to the SYBR® gold fluorescence (λ>500 nm) hit the detector 28. The detector 28 can be a photodiode or a photomultiplier tube (PMT). When light hits the photocathode of the PMT or the photodiode, the light photons are converted into electricity that is then measured. The current is proportional to the intensity of fluorescent light that emits from sample 12, which is further proportional to the number of bacteria present in the sample. The intensity of the fluorescence is proportional to the number of total bacteria, a calibration curve 30 of reference intensities plotted against bacteria count, such as illustrated in FIG. 5 can be used to determine the number of bacteria. The calibration curve illustrated in FIG. 5 can be for a standard volume, so if the sample volume is different from the standard volume for the curve, the measure intensity can be scaled to use the calibration because of the aforementioned linear relationship.

It some instances, a total bacteria count for a specific bacteria interest may be desired. In these instances, phages can be used. It has been shown in the prior art that phages 10 are able to inject their fluorescently labeled DNA/RNA into its host cell. FIGS. 3A and 3B are color photographs of this phenomenon. FIGS. 3A and 3B illustrate samples of two bacterial species, Salmonella and Bacillus megaterium, and a phage whose host is Salmonella, P22, was prepared. The DNA of P22 was fluorescently labeled with the nucleic acid SYBR® gold. Another nucleic acid, DAPI, was also added to the sample. After incubation for 10 minutes, the sample was filtered onto a ceramic filter. Images were taken in both the DAPI and SYBR® channels. The DAPI stains the DNA of the two bacterial species and the phage. Consequently the DAPI channel shows all three species. In the SYBR® channel, the source of the SYBR® is through the fluorescently labeled DNA of phage P22. In this channel, only P22 and Salmonella are observed. The phage P22 has injected its fluorescently labeled DNA inside its host, Salmonella.

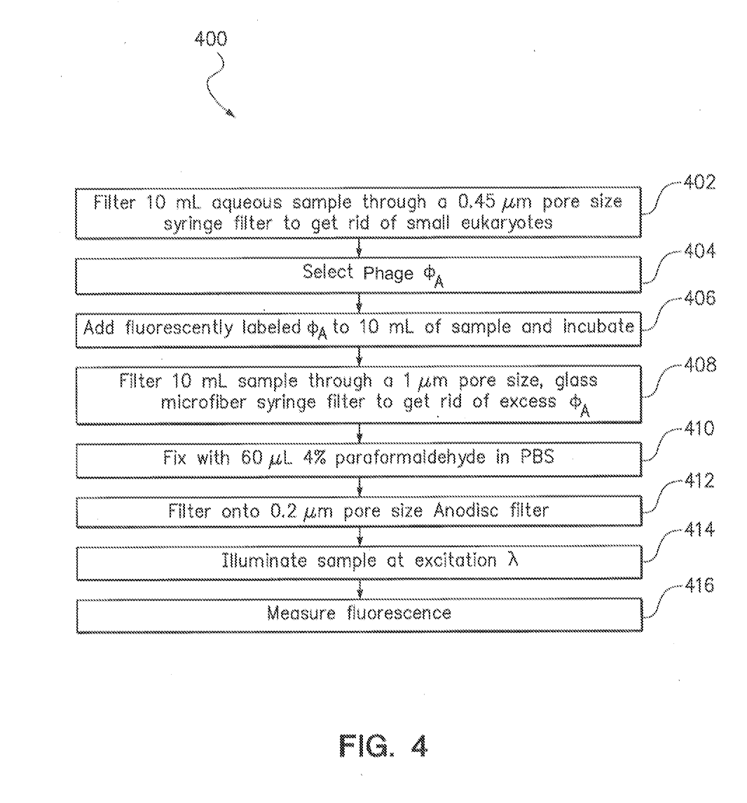

In several embodiments of the present invention, phages can be incorporated to obtain total bacteria counts for a specific bacteria of interest. Referring now to FIG. 4, a method 400 for some of these embodiments is shown. As shown, method 400 includes the initial step 402 removing the eukaryotes from the sample. Like for method 100, a 10 mL sample can be filtered through a 0.45 μm pore size syringe filter. Either polycarbonate (PC) or polyvinylidene (PVDF) filters can be used as they exhibit low protein binding.

Once the eukaryotes have been removed, and as indicated by step 404, a phage Φ_{A} that is known to react with the bacteria species A of interest can be selected. The phage is fluorescently tagged. Next, and shown in step 406, fluorescently tagged phage Φ_{A} can be added to the sample which is allowed to incubate. The phage-to-host ratio is such that multiple phages will inject their fluorescently labeled nucleic acid inside the bacterial host cell. After incubation (typically 10 minutes), the filtrate is filtered through a glass microfiber filter as shown by step 408 in FIG. 4. Step 408 can be accomplished so that any excess phage binds electrostatically to the glass microfibers. This traps any excess phage from the sample and only allows the bacteria though.

To prevent lysis of the infected bacteria and to preserve the sample for additional confirmation, and as indicated by step 410, the phage/host reaction can be quenched by the addition of 60 μL of 4% paraformaldehyde in PBS. As in the case of the total bacteria analysis without using phages (method 100), the paraformaldehyde can preserve the sample so that additional analysis of the sample can be done. Epifluorescent microscopy could be done to verify the counts. Raman microscopy can also be done, as it has been shown that each bacterial species has its own characteristic Raman signature.

Referring again to FIG. 4, the sample can then be filtered (step 412) onto a 0.2 μm pore size Anodisc membrane filter. The filter is then placed in a sensor shown such as device 10 shown in FIG. 2. Filter 12 can be placed in holder 14 and the methods can include illuminating the sample (step 414) with a light source 16 at a wavelength that corresponds to the excitation wavelength for the fluorescent tag that is being used. As shown in FIG. 4, the method 400 can also include the step 416 of measuring the resulting fluorescent of the sample and comparing the measure fluorescence with a calibration curve 30 to determine total bacteria count of the species of interest. The sensor can be the same as that used for the total bacteria detection. The only difference is that only bacteria of interest that have been infected by the selected phage will fluoresce. The intensity of the fluorescence is proportional to the number of infected bacteria. A representative calibration curve 30, as cited above and shown in FIG. 5, can be used to determine the number of bacteria, as also described above.

The use of the terms “a” and “an” and “the” and similar references in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for determining total prokaryote count in a sample, said sample containing an unknown amount of eukaryotes and prokaryotes, said total prokaryote count in said sample being indicative of a bacteria count in said sample, said method being used by remote operators in the field and comprising the steps of:
A) removing said eukaryotes from said sample;
B) tagging said sample with a fluorescent tag that illuminates in the presence of said unknown amount of prokaryotes;
C) filtering said sample onto an optical substrate
D) illuminating said optical substrate with a fluorescent light source at a wavelength corresponding to an excitation wavelength for said fluorescent tag, to establish a test intensity for said sample; and,
E) comparing said test intensity to reference intensities to determine said total prokaryote count.

2. The method of claim 1, wherein said step A) is accomplished by filtering said sample through a 0.45 μm pore size syringe filter.

3. The method of claim 2, wherein said syringe filter is made of a low protein binding material selected from the group consisting of polycarbonate (PC) or polyvinylidene (PVDF) materials.

4. (canceled)

5. (canceled)

6. (canceled)

7. A device for determining a total bacteria count of bacteria in a sample, said bacteria containing eukaryotes and prokaryotes, said device comprising:
a filter for removing said eukaryotes from said sample;
a fluorescent tag, said fluorescent tag being incorporated into said sample;
an optical substrate, said sample and said fluorescent tag being placed on said optica substrate
a light source illuminating said optical substrate at a wavelength corresponding to an excitation wavelength for said fluorescent tag; and,
a light sensor for receiving fluorescent light at a wavelength corresponding to an emitting wavelength for said fluorescent tag.

8. The device of claim 7, wherein said fluorescent tag is SBYR® Gold cyanine dye.

9. The device of claim 8, wherein said light source wavelength is between 450 and 550 nm.

10. The device of claim 9, wherein said light sensor receives said fluorescent light of said emitting wavelength of greater than 500 nanometers.

11-19. (canceled)
